(19) United States
(12) Patent Application Publication
(10) Pub. No.: US 2013/0257908 A1
(43) Pub. Date: Oct. 3, 2013

(54) OBJECT DISPLAY DEVICE, OBJECT DISPLAY METHOD, AND OBJECT DISPLAY PROGRAM

(71) Applicants: Manabu Ota, Chiyoda-ku (JP); Yasuo Morinaga, Chiyoda-ku (JP)

(72) Inventors: Manabu Ota, Chiyoda-ku (JP); Yasuo Morinaga, Chiyoda-ku (JP)

(73) Assignee: NTT DOCOMO, INC., Tokyo (JP)

(21) Appl. No.: 13/993,470

(22) PCT Filed: Dec. 26, 2011
(86) PCT No.: PCT/JP11/80073

§ 371 Date: Jun. 12, 2013

(30) Foreign Application Priority Data
Feb. 23, 2011 (JP) 2011-037211

(51) Int. Cl. G06T 19/00

(52) U.S. Cl. CPC G06T 19/006
USPC 345/633

(57) ABSTRACT

An object display device includes a virtual object process unit that processes an object based on imaging information that an imaging unit references upon acquisition of an image in real space, an image synthesis unit that superimposes the processed object on the image in real space, and a display unit that displays a superimposed image. Accordingly, the feature of the image in real space is reflected in the object superimposed. Thus, a sense of incongruity upon superimposing and displaying the object on the image in real space is reduced.

### TECHNICAL FIELD

The present invention relates to an object display device, an object display method, and an object display program.

### BACKGROUND ART

In recent years, services based on augmented reality (AR) technology have been developed and provided. For example, a technique in which an object arranged around a location of a mobile terminal is acquired and an object including various kinds of information or an image is superimposed and displayed on an image in real space acquired by a camera provided to the mobile terminal is known. A technique in which a predetermined marker is detected from an image in real space acquired by a camera in a mobile terminal and an object associated with the marker is superimposed on the image in real space and displayed on a display is also known. Meanwhile, as a technique for taking into consideration the color of an object upon superimposing the object on an image in real space, a technique in which the color of the object is corrected based on the color of a marker arranged in real space is known (for example, see Patent Literature 1).

### CITATION LIST

### Patent Literature

[Patent Literature 1] Japanese Patent Application Laid-Open Publication No. 2010-170316

### SUMMARY OF INVENTION

### Technical Problem

However, since an image of an object or a 3D object is merely superimposed on an imaged image in real space in normal AR technology, there have been cases where a sense of incongruity is caused in a synthesized image due to the difference in image quality or the like in two images. A particular marker is necessary and it is necessary for a terminal to have information relating to the color of the marker in advance in the technique described in Patent Literature 1. Thus, implementation thereof is not easy.

Thus, the present invention is made in view of the problem described above, and it is an object to provide an object display device, an object display method, and an object display program with which it is possible to easily reduce a sense of incongruity upon superimposing and displaying an object on an image in real space in AR technology.

### Solution to Problem

To solve the problem described above, an object display device according to one aspect of the present invention is an object display device that superimposes and displays an object on an image in real space, including object information acquiring means for acquiring object information relating to the object to be displayed, imaging means for acquiring the image in real space, imaging information acquiring means for acquiring imaging information that the imaging means references upon acquisition of the image in real space, object process means for processing, based on the imaging information acquired by the imaging information acquiring means, the object acquired by the object information acquiring means, image synthesizing means for generating an image in which the object processed by the object process means is superimposed on the image in real space acquired by the imaging means, and display means for displaying the image generated by the image synthesizing means.

To solve the problem described above, an object display method according to another aspect of the present invention is an object display method performed by an object display device that superimposes and displays an object on an image in real space, the method including an object information acquisition step of acquiring object information relating to the object to be displayed, an imaging step of acquiring the image in real space, an imaging information acquisition step of acquiring imaging information that is referenced upon acquisition of the image in real space in the imaging step, an object process step of processing, based on the imaging information acquired in the imaging information acquisition step, the object acquired in the object information acquisition step, an image synthesis step of generating an image in which the object processed in the object process step is superimposed on the image in real space acquired in the imaging step, and a display step of displaying the image generated in the image synthesis step.

To solve the problem described above, an object display program according to yet another aspect of the present invention is an object display program for causing a computer to function as an object display device that superimposes and displays an object on an image in real space, such that the computer is caused to achieve an object information acquisition function of acquiring object information relating to the object to be displayed, an imaging function of acquiring the image in real space, an imaging information acquisition function of acquiring imaging information that the imaging function references upon acquisition of the image in real space, an object process function of processing, based on the imaging information acquired with the imaging information acquisition function, the object acquired with the object information acquisition function, an image synthesis function of generating an image in which the object processed with the object process function is superimposed on the image in real space acquired with the imaging function, and a display function of displaying the image generated with the image synthesis function.

With the object display device, the object display method, and the object display program, the object is processed based on the imaging information that the imaging means references upon acquisition of the image in real space, and the processed object is superimposed and displayed on the image in real space. Thus, the feature of the acquired image in real space is reflected in the displayed object. A sense of incongruity upon superimposing and displaying the object on the image in real space is therefore reduced easily.

It is possible that the object display device according to one aspect of the present invention further include position measuring means for measuring a location of the object display device and object distance calculating means, the object information include position information representing an arrangement position of the object in real space, the imaging information include a focal length, the object distance calculating means calculate a distance from the object display device to the object based on the position information of the object acquired by the object information acquiring means and the location of the object display device measured by the position measuring means, and the object process means perform, with respect to the object, a blurring process for imitating an image acquired in a case where an imaging subject is present at a position displaced from the focal length, in accordance with a difference of the focal length included in the imaging information acquired by the imaging information acquiring means and the distance to the object calculated by the object distance calculating means.

With the configuration described above, what is called a blurring process is carried out with respect to the object in the case where the object is located in the position that is out of focus in the image in real space due to the focal length that the imaging means has used. The blurring process is image process processing for imitating the image acquired in the case where the imaging subject is present at the position displaced from the focal length. Accordingly, since the object for which the blurring process has been carried out is superimposed in a region that is out of focus in real space, a superimposed image in which a sense of incongruity is reduced is obtained.

In the object display device according to one aspect of the present invention, it is possible that the imaging information include a set value relating to image quality upon acquiring the image in real space, and the object process means process the object in accordance with the set value included in the imaging information acquired by the imaging information acquiring means.

With the configuration described above, the image quality of the acquired image in real space is reflected in the image quality of the processed object, since the object is processed in accordance with the set value relating to the image quality of the image in real space in the imaging means. Thus, a sense of incongruity upon superimposing and displaying the object on the image in real space is reduced.

In the object display device according to one aspect of the present invention, it is possible that the imaging information include responsivity information with which responsivity in the imaging means is determined, and the object process means carry out a noise process of adding a particular noise to the object in accordance with the responsivity information included in the imaging information acquired by the imaging information acquiring means.

There are cases where noise occurs in the image acquired by the imaging means, in accordance with the responsivity in the imaging means. With the configuration described above, a sense of incongruity upon superimposing and displaying the object on the image in real space is reduced since noise similar to the noise that has occurred in the image in real space is added to the object in accordance with the responsivity information.

In the object display device according to one aspect of the present invention, it is possible that the imaging information include color correction information with which a color of the image acquired by the imaging means is corrected, and the object process means carry out a color correction process of correcting a color of the object in accordance with the color correction information included in the imaging information acquired by the imaging information acquiring means.

In this case, a process of correcting the color of the object is carried out in accordance with the color correction information that the imaging means uses for acquisition of the image. Accordingly, the color of the object can be brought closer to the color of the image in real space acquired by the imaging means. Thus, a sense of incongruity upon superimposing and displaying the object on the image in real space is reduced.

### Advantageous Effects of Invention

It is possible to easily reduce a sense of incongruity upon superimposing and displaying an object on an image in real space in AR technology.

### BRIEF DESCRIPTION OF DRAWINGS

FIG. 1 is a block diagram showing the functional configuration of an object display device.

FIG. 2 is a hardware block diagram of the object display device.

FIG. 3 is a view showing an example of the configuration of a virtual object storage unit and stored data.

FIGS. 4(a) and 4(b) are views showing an example of an image in which a virtual object is superimposed on an image in real space.

FIGS. 5(a) and 5(b) are views showing an example of an image in which a virtual object is superimposed on an image in real space.

FIG. 6 is a flowchart showing the processing content of an object display method.

FIG. 7 is a block diagram showing the functional configuration of an object display device of a second embodiment.

FIG. 8 is a view showing an example of the configuration of a virtual object storage unit of the second embodiment and stored data.

FIG. 9 is a view showing an example of an image in which virtual objects are superimposed on an image in real space in the second embodiment.

FIG. 10 is a flowchart showing the processing content of an object display method of the second embodiment.

FIG. 11 is a flowchart showing the processing content of the object display method of the second embodiment.

FIG. 12 is a view showing the configuration of an object display program in the first embodiment.

FIG. 13 is a view showing the configuration of an object display program in the second embodiment.

### DESCRIPTION OF EMBODIMENTS

An embodiment for an object display device, an object display method, and an object display program according to the present invention will be described with reference to the drawings. Note that, in cases where possible, the same portions are denoted by the same reference signs, and redundant descriptions are omitted.

### First Embodiment

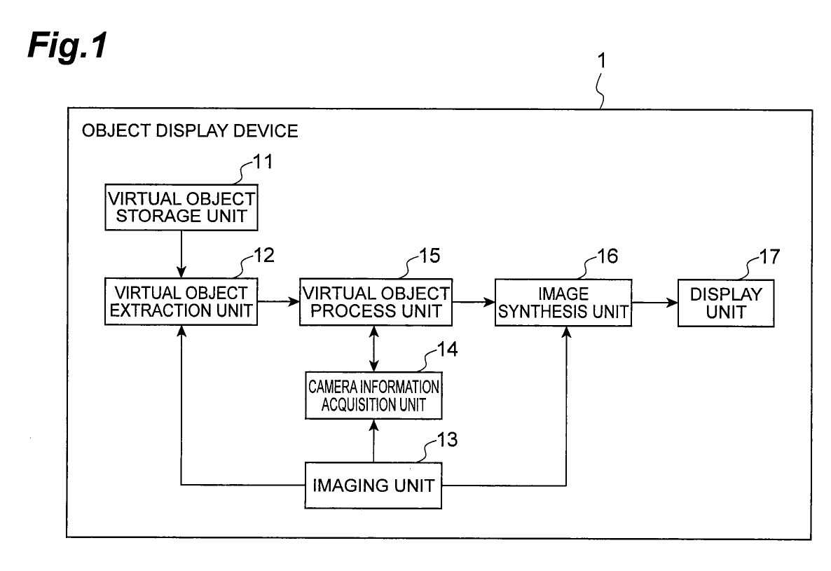

FIG. 1 is a block diagram showing the functional configuration of an object display device 1. The object display device 1 of this embodiment is a device that superimposes and displays an object on an image in real space and is, for example, a mobile terminal with which communication via a mobile communication network is possible.

As a service based on AR technology using a device such as a mobile terminal, there is one, for example, in which a predetermined marker is detected from an image in real space acquired by a camera in a mobile terminal and an object associated with the marker is superimposed on the image in real space and displayed on a display. As a similar service, there is one in which an object arranged around the location of a mobile terminal is acquired and the object is superimposed and displayed in association with the position within an image in real space acquired by a camera provided to the mobile terminal. In a first embodiment, the following description is given for the object display device 1 receiving the provided service of the former. However, this is not limiting.

As shown in FIG. 1, the object display device 1 functionally includes a virtual object storage unit 11, a virtual object extraction unit 12 (object information acquiring means), an imaging unit 13 (imaging means), a camera information acquisition unit 14 (imaging information acquiring means), a virtual object process unit 15 (object process means), an image synthesis unit 16 (image synthesizing means), and a display unit 17 (display means).

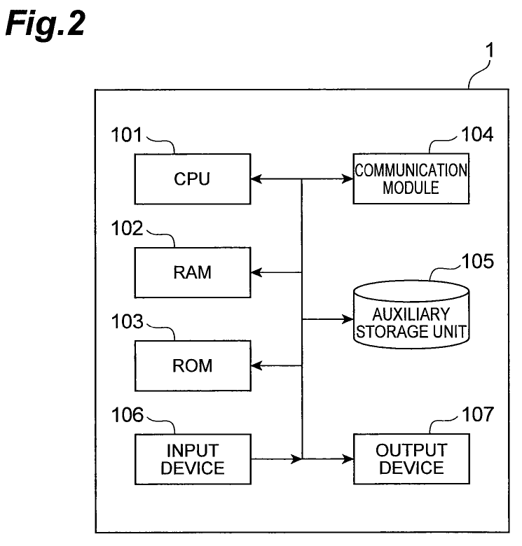

FIG. 2 is a hardware configuration diagram of the object display device 1. As shown in FIG. 2, the object display device 1 is physically configured as a computer system including a CPU 101, a RAM 102 and a ROM 103 that are a main storage device, a communication module 104 that is a data transmission/reception device, an auxiliary storage device 105 such as a hard disk or flash memory, an input device 106 such as a keyboard that is an input device, an output device 107 such as a display, and the like. Each function shown in FIG. 1 is achieved by loading predetermined computer software on hardware such as the CPU 101 or the RAM 102 shown in FIG. 2 to cause the communication module 104, the input device 106, and the output device 107 to work under the control of the CPU 101 and perform reading and writing of data in the RAM 102 or the auxiliary storage device 105. Again, referring to FIG. 1, each functional unit of the object display device 1 will be described in detail.

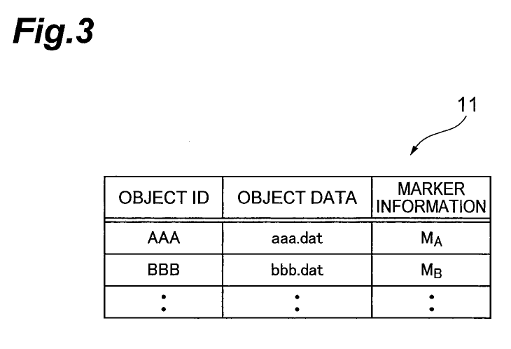

The virtual object storage unit 11 is storage means for storing virtual object information that is information relating to a virtual object. FIG. 3 is a view showing an example of the configuration of the virtual object storage unit 11 and data stored therein. As shown in FIG. 3, the virtual object information includes data such as object data and marker information associated with an object ID with which the object is identified.

The object data is, for example, image data of the object. The object data may be data of a 3D object for representing the object. The marker information is information relating to a marker associated with the object and includes, for example, image data or 3D object data of the marker. That is, in the case where the marker represented by the marker information is extracted from the image in real space in this embodiment, the object associated with the marker information is superimposed and displayed in association with the marker within the image in real space.

The virtual object extraction unit 12 is a unit that acquires object information from the virtual object storage unit 11. Specifically, the virtual object extraction unit 12 first attempts to detect the marker from the image in real space acquired by the imaging unit 13. Since the marker information relating to the marker is stored in the virtual object storage unit 11, the virtual object extraction unit 12 acquires the marker information from the virtual object storage unit 11, searches the image in real space based on the acquired marker information, and attempts to extract the marker. In the case where the marker is detected from the image in real space, the virtual object extraction unit 12 extracts the object information that is associated with the marker in the virtual object storage unit 11.

The imaging unit 13 is a unit that acquires the image in real space and is configured of, for example, a camera. The imaging unit 13 references imaging information upon acquisition of the image in real space. The imaging unit 13 sends the acquired image in real space to the virtual object extraction unit 12 and the image synthesis unit 16. Also, the imaging unit 13 sends the imaging information to the camera information acquisition unit 14.

The camera information acquisition unit 14 is a unit that acquires, from the imaging unit 13, the imaging information the imaging unit 13 references upon acquisition of the image in real space. The camera information acquisition unit 14 sends the acquired imaging information to the virtual object process unit 15.

The imaging information includes, for example, a set value relating to the image quality upon acquiring the image in real space.

This set value includes, for example, responsivity information with which the responsivity in the imaging unit 13 is determined. Examples of the responsivity information include what is called the ISO speed. The set value includes, for example, color correction information with which the color of the image acquired by the imaging unit 13 is corrected. The color correction information includes, for example, information relating to white balance. The color correction information may include other known parameters for correcting the color. Also, the imaging information may include parameters such as the focal length and depth of field.

The virtual object process unit 15 is a unit that processes the object acquired by the virtual object extraction unit 12 based on the imaging information acquired by the camera information acquisition unit 14.

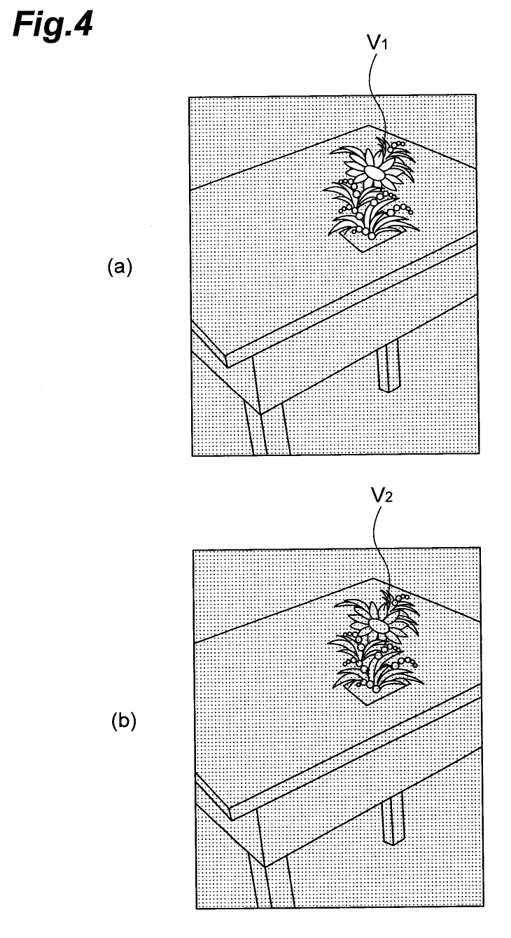

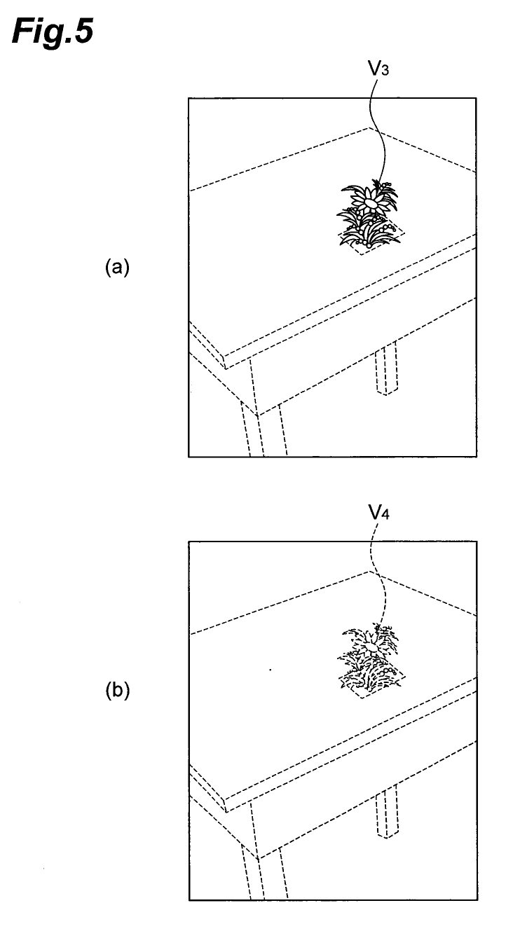

Specifically, the virtual object process unit 15 processes the object in accordance with the set value included in the imaging information acquired by the camera information acquisition unit 14. Subsequently, an example of process processing of the object will be described with reference to FIGS. 4 and 5.

For example, the virtual object process unit 15 carries out a noise process of adding a particular noise to the object in accordance with the responsivity information included in the imaging information acquired by the camera information acquisition unit 14. FIGS. 4(a) and 4(b) are views showing a display example of an image in the case where noise process processing of the object is carried out. Generally, there are cases where noise occurs in an image imaged with high responsivity under an environment where the amount of light is small. The particular noise is an imitation of the noise that can occur in such a situation. The virtual object process unit 15 carries out, as the noise process, image processing in which an image pattern imitating the noise occurring in such a case is superimposed on the object.

For example, the virtual object process unit 15 can have, in association with a value of the responsivity information, information such as the shape, amount, or density of noise to be added to the object (not shown). Then, the virtual object process unit 15 can add the noise in accordance with the value of the responsivity information from the camera information acquisition unit 14 to the object.

FIG. 4(a) is an example of the image in real space superimposed with the object for which the noise process is not carried out. Since an object V₁ to which noise is not added is superimposed on the image in real space in which noise has occurred as shown in FIG. 4(a), the image quality differs between a region in which the object V₁ is displayed and a region other than the object V₁, causing a sense of incongruity.

By contrast, FIG. 4(b) is an example of the image in real space superimposed with the object for which the noise process has been carried out. Since an object V₂ to which noise is added is superimposed on the image in real space in which noise has occurred as shown in FIG. 4(b), the image quality of a region in which the object V₂ is displayed can be brought closer to the image quality of a region other than the object V₂, and the sense of incongruity from an entire image is reduced.

The virtual object process unit 15 carries out a color correction process of correcting the color of the object in accordance with the color correction information included in the imaging information acquired by the camera information acquisition unit 14 for example.

FIGS. 5(a) and 5(b) are views showing a display example of an image in the case where color correction process processing of the object is carried out. Generally, a technique in which correction processing for the color of an acquired image is performed based on information such as the amount of light in an imaging environment acquired by a sensor or information obtained by analysis of an imaged image and relating to the color of the image is known. Examples of the information for the color correction include information relating to white balance or illuminance information. The imaging unit 13 corrects the color of the acquired image in real space using the color correction information and sends the image in which the color is corrected to the image synthesis unit 16.

The virtual object process unit 15 can acquire the color correction information that the imaging unit 13 has used via the camera information acquisition unit 14 and can carry out the color correction process of correcting the color of the object based on the acquired color correction information. The color of the object processed in this manner becomes a color similar to or resembling the color of the image in real space.

FIG. 5(a) is an example of the image in real space superimposed with the object for which the color correction process is not carried out. Since an object V₃ for which the color is not corrected is superimposed on the image in real space in which color processing has been carried out as shown in FIG. 5(a), the colors of a region in which the object V₃ is displayed and a region other than the object V₃ differ, causing a sense of incongruity.

By contrast, FIG. 5(b) is an example of the image in real space superimposed with the object for which the color correction process has been carried out. Since an object V₄ for which the color correction process has been carried out is superimposed on the image in real space in which some color processing has been carried out as shown in FIG. 5(b), the color of a region in which the object V₄ is displayed can be brought closer to the color of a region other than the object V₄. Therefore, the sense of incongruity from an entire image is reduced.

The image synthesis unit 16 is a unit that generates an image in which the object for which an image process has been performed by the virtual object process unit 15 is superimposed on the image in real space acquired by the imaging unit 13. Specifically, the image synthesis unit 16 generates a superimposed image in which the object is superimposed in a position specified by the position of the marker within the image in real space. The image synthesis unit 16 sends the generated superimposed image to the display unit 17.

The display unit 17 is a unit that displays the image generated by the image synthesis unit 16 and is configured of a device such as a display.

Subsequently, the processing content of an object display method performed by the object display device 1 will be described.

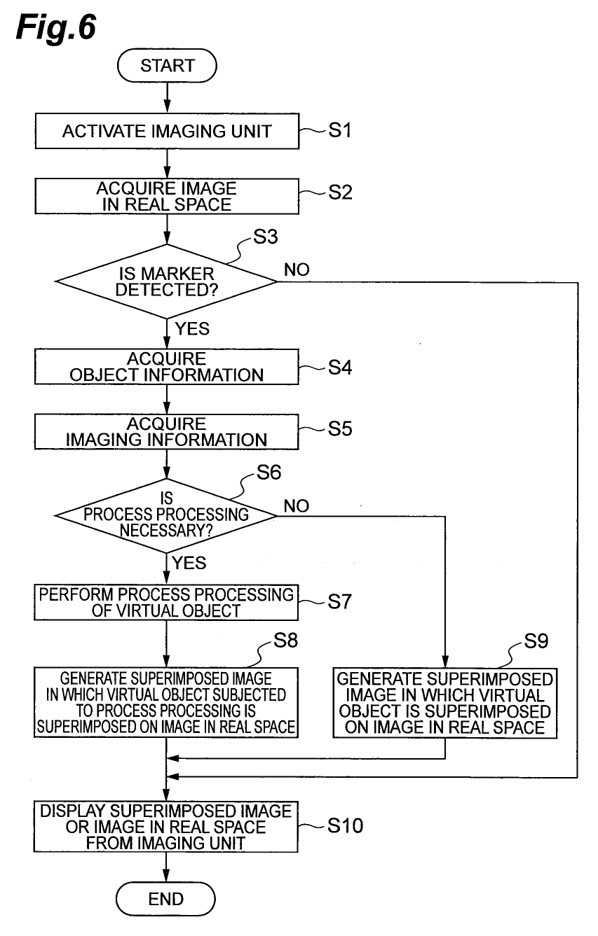

FIG. 6 is a flowchart showing the processing content of the object display method.

First, the object display device 1 activates the imaging unit 13 (S 1). Subsequently, the imaging unit 13 acquires the image in real space (S2). Next, the virtual object extraction unit 12 searches the image in real space based on the marker information acquired from the virtual object storage unit 11 and attempts to extract the marker (S3). Then, in the case where the marker is extracted, the processing procedure proceeds to step S4. In the case where the marker is not extracted, the processing procedure proceeds to step S10.

In step S4, the virtual object extraction unit 12 acquires the object information associated with the extracted marker from the virtual object storage unit 11 (S4). Next, the camera information acquisition unit 14 acquires the imaging information from the imaging unit 13 (S5). Subsequently, the virtual object process unit 15 determines whether or not process processing for the object is necessary based on the imaging information acquired in step S5 (S6). The virtual object process unit 15 can determine the necessity of the process processing for the object by, for example, a standard of whether or not a value of the acquired imaging information is a predetermined threshold value or greater. In the case where it is determined that the process processing for the object is necessary, the processing procedure proceeds to step S7. In the case where it is not determined that the process processing for the object is necessary, the processing procedure proceeds to step S9.

In step S7, the virtual object process unit 15 carries out the process processing such as the noise process or color correction process with respect to the object in accordance with the set value included in the imaging information acquired by the camera information acquisition unit 14 (S7).

The image synthesis unit 16 generates the superimposed image in which the object for which the process processing has been performed in step S7 is superimposed on the image in real space acquired by the imaging unit 13 (S8). In step S9, by contrast, the image synthesis unit 16 generates a superimposed image in which the object for which the process processing is not performed is superimposed on the image in real space acquired by the imaging unit 13 (S9). Then, the display unit 17 displays the superimposed image generated by the image synthesis unit 16 in step S8 or S9 or the image in real space on which the object is not superimposed (S10).

With the object display device and the object display method of this embodiment, the object is processed based on the imaging information that the imaging unit 13 references upon acquisition of the image in real space, and the processed object is superimposed and displayed on the image in real space. Therefore, the feature of the acquired image in real space is reflected in the displayed object. Since the object is processed in accordance with the set value relating to the image quality of the image in real space in the imaging unit 13, the image quality of the acquired image in real space is reflected in the image quality of the processed object. Thus, a sense of incongruity upon superimposing and displaying the object on the image in real space is reduced.

### Second Embodiment

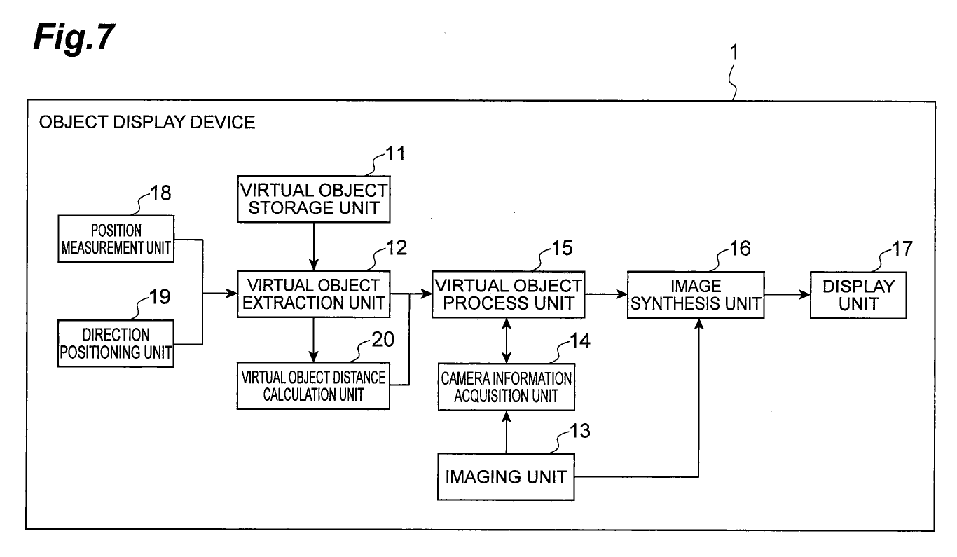

As a service based on AR technology for the object display device 1 in a second embodiment, one in which an object arranged around the location of a mobile terminal is acquired and the object is superimposed and displayed in association with the position within an image in real space acquired by a camera provided to the mobile terminal is assumed. However, this is not limiting. FIG. 7 is a block diagram showing the functional configuration of the object display device 1 in the second embodiment. The object display device 1 of the second embodiment includes, in addition to each functional unit that the object display device 1 of the first embodiment (see FIG. 1) includes, a position measurement unit 18 (position measuring means), a direction positioning unit 19, and a virtual object distance calculation unit 20 (object distance calculating means).

The position measurement unit 18 is a unit that measures the location of the object display device 1 and acquires information relating to the measured location as position information. The location of the object display device 1 is measured by positioning means such as a GPS device. The position measurement unit 18 sends the position information to the virtual object extraction unit 12.

The direction positioning unit 19 is a unit that measures the imaging direction of the imaging unit 13 and is configured of a device such as a geomagnetic sensor. The direction positioning unit 19 sends measured direction information to the virtual object extraction unit 12. Note that the direction positioning unit 19 is not a mandatory component in the present invention.

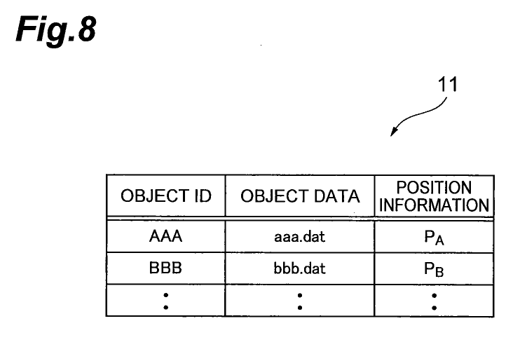

The virtual object storage unit 11 in the second embodiment has a configuration different from the virtual object storage unit 11 in the first embodiment. FIG. 8 is a view showing an example of the configuration of the virtual object storage unit 11 in the second embodiment and stored data. As shown in FIG. 8, virtual object information includes data such as object data and the position information associated with an object ID with which the object is identified.

The object data is, for example, image data of the object. The object data also may be data of a 3D object for representing the object.

The position information is information representing the arrangement position of the object in real space and is represented by, for example, three-dimensional coordinate values.

The virtual object storage unit 11 may store object information in advance. The virtual object storage unit 11 may accumulate the object information acquired via predetermined communication means (not shown) from a server (not shown) that stores and manages the object information, based on the position information acquired by the position measurement unit 18. In this case, the server that stores and manages the object information provides the object information of a virtual object arranged around the object display device 1.

The virtual object extraction unit 12 acquires the object information from the virtual object storage unit 11 based on the location of the object display device 1. Specifically, based on the position information measured by the position measurement unit 18 and the direction information measured by the direction positioning unit 19, the virtual object extraction unit 12 determines a range of real space to be displayed in the display unit 17 and extracts the virtual object of which the arrangement position is included in that range. In the case where the arrangement positions of a plurality of virtual objects are included in the range of real space to be displayed in the display unit 17, the virtual object extraction unit 12 extracts the plurality of virtual objects.

Note that it is possible that the virtual object extraction unit 12 carry out extraction of the virtual object without using the direction information. The virtual object extraction unit 12 sends the extracted object information to the virtual object distance calculation unit 20 and the virtual object process unit 15.

The virtual object distance calculation unit 20 is a unit that calculates the distance from the object display device 1 to the virtual object based on the position information of the virtual object acquired by the virtual object extraction unit 12. Specifically, the virtual object distance calculation unit 20 calculates the distance from the object display device 1 to the virtual object based on the position information measured by the position measurement unit 18 and the position information of the virtual object included in the virtual object information. In the case where the plurality of virtual objects are extracted by the virtual object extraction unit 12, the virtual object distance calculation unit 20 calculates the distance from the object display device 1 to each virtual object. The virtual object distance calculation unit 20 sends the calculated distance to the virtual object process unit 15.

The camera information acquisition unit 14 acquires, from the imaging unit 13, imaging information that the imaging unit 13 references upon acquisition of the image in real space. The imaging information acquired herein includes, in a similar manner to the first embodiment, a set value relating to the image quality upon acquiring the image in real space. This set value includes, for example, responsivity information with which the responsivity in the imaging unit 13 is determined and color correction information. The imaging information includes parameters such as the focal length and depth of field.

The virtual object process unit 15 processes the object acquired by the virtual object extraction unit 12 based on the imaging information acquired by the camera information acquisition unit 14. The virtual object process unit 15 in the second embodiment also can carry out a noise process in accordance with the responsivity information and a color correction process in accordance with the color correction information in a similar manner to the first embodiment.

The virtual object process unit 15 in the second embodiment can carry out, in accordance with the difference of the focal length included in the imaging information and the distance to the virtual object calculated by the virtual object distance calculation unit 20, a blurring process with respect to an image of the object for imitating an image acquired in the case where an imaging subject is present at a position displaced from the focal length.

Since the imaging unit 13 acquires the image in real space using a predetermined focal length based on a setting or the like by a user, the acquired image may have a region of a clear image due to coincidence of the distance to an imaging subject and the focal length and a region of an unclear image due to discrepancy between the distance to an imaging subject and the focal length. This unclear image can also be referred to as a blurry image. The virtual object process unit 15 carries out, with respect to the object to be superimposed in the region of the blurry image in the image in real space, the blurring process for providing a blur of the same degree as in the region of the image. The virtual object process unit 15 can carry out the blurring process using a known image processing technique. One example thereof will be described below.

The virtual object process unit 15 can calculate a size B of the blur with formula (I) below.

B=(mD/W)(T/(L+T) (1)

B: Size of blur
D: Effective aperture diameter which equals focal length divided by F-number
W: Diagonal length of imaging range
L: Distance from camera to subject
T: Distance from subject to background
m: Ratio of circle of confusion diameter and diagonal length of image sensor
Based on the size B of the blur, the virtual object process unit 15 determines the blur amount of the blurring process and carries out the blurring process of the virtual object. Note that it may be such that the virtual object process unit 15 determines the necessity and the blur amount of the blurring process for each object using the depth of field in addition to the focal length.

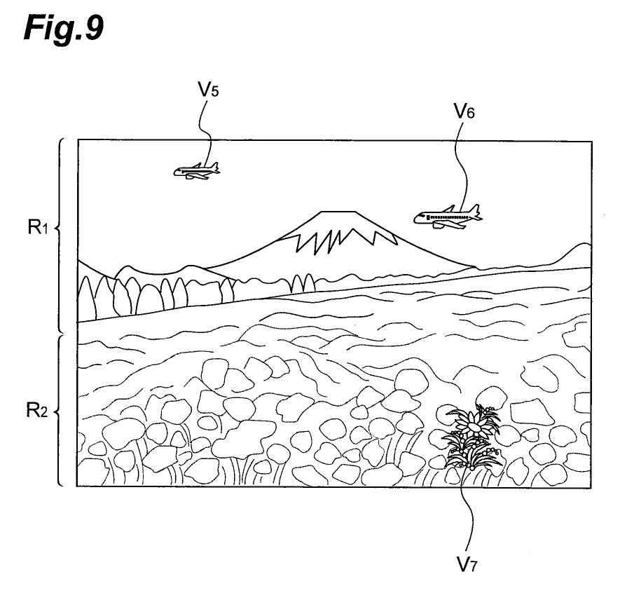

FIG. 9 is a view showing an example of a superimposed image generated in this embodiment. In an image in real space shown in FIG. 9, an image in a region R₁ is acquired clearly since the focal length is set to correspond to the position of a mountain that is far away. By contrast, an image in a region R₂ capturing an imaging subject that is at a position displaced from the focal length is unclear and is, in other words, a blurry image. In such a case, the virtual object process unit 15 does not carry out the blurring process with respect to objects V₅ and V₆ superimposed in the region R₁. The virtual object process unit 15, however, carries out the blurring process with respect to an object V₇ superimposed in the region R₂. At this time, the virtual object process unit 15 can set the blur amount based on the displacement between the position of the object V₇ and the focal length.

The image synthesis unit 16 generates a superimposed image in which the object for which an image process has been performed by the virtual object process unit 15 is superimposed on the image in real space acquired by the imaging unit 13. The display unit 17 displays the image generated by the image synthesis unit 16.

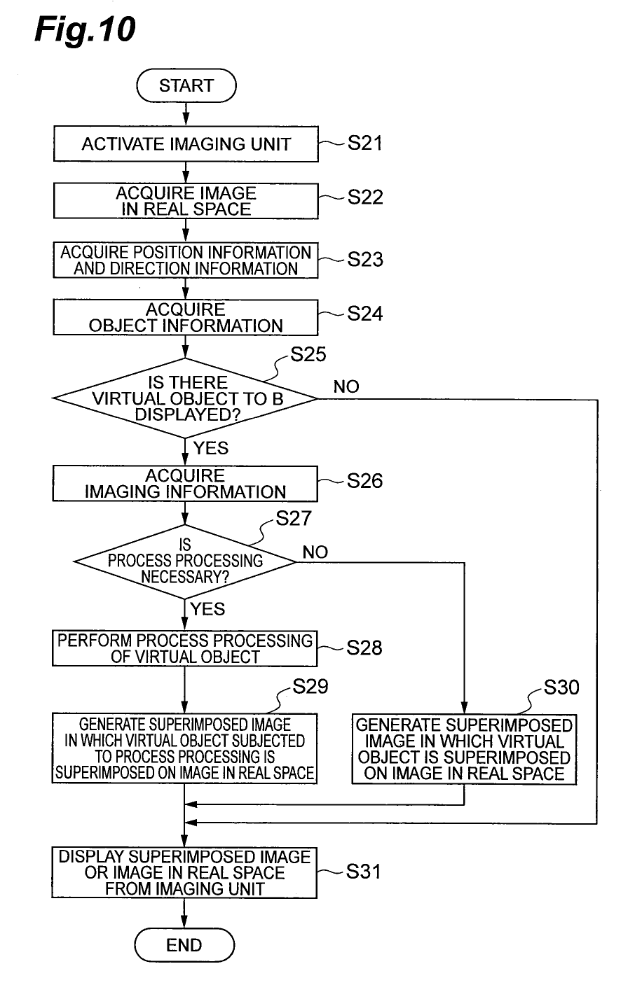

Subsequently, the processing content of an object display method performed by the object display device 1 in the second embodiment will be described. FIG. 10 is a flowchart showing the processing content of the object display method in the case where the object display device 1 carries out the noise process, the color correction process, and the like in a similar manner to the first embodiment.

First, the object display device 1 activates the imaging unit 13 (S21). Subsequently, the imaging unit 13 acquires the image in real space (S22). Next, the position measurement unit 18 measures the location of the object display device 1, acquires the information relating to the measured location as the position information (S23), and sends the acquired position information to the virtual object extraction unit 12. It is possible that the direction positioning unit 19 measure the imaging direction of the imaging unit 13 in step S23.

Next, based on the position information of the object display device 1, the virtual object extraction unit 12 determines the range of real space to be displayed in the display unit 17 and acquires the virtual object information of the virtual object of which the arrangement position is included in that range from the virtual object storage unit 11 (S24). Subsequently, the virtual object extraction unit 12 determines whether or not there is a virtual object to be displayed (S25). That is, in the case where the object information is acquired in step S24, the virtual object extraction unit 12 determines that there is a virtual object to be displayed. In the case where it is determined that there is a virtual object to be displayed, the processing procedure proceeds to step S26. In the case where it is not determined that there is a virtual object to be displayed, the processing procedure proceeds to step S31.

The processing content of subsequent steps S26 to S31 is similar to steps S5 to S10 in the flowchart (FIG. 6) showing the processing content of the first embodiment.

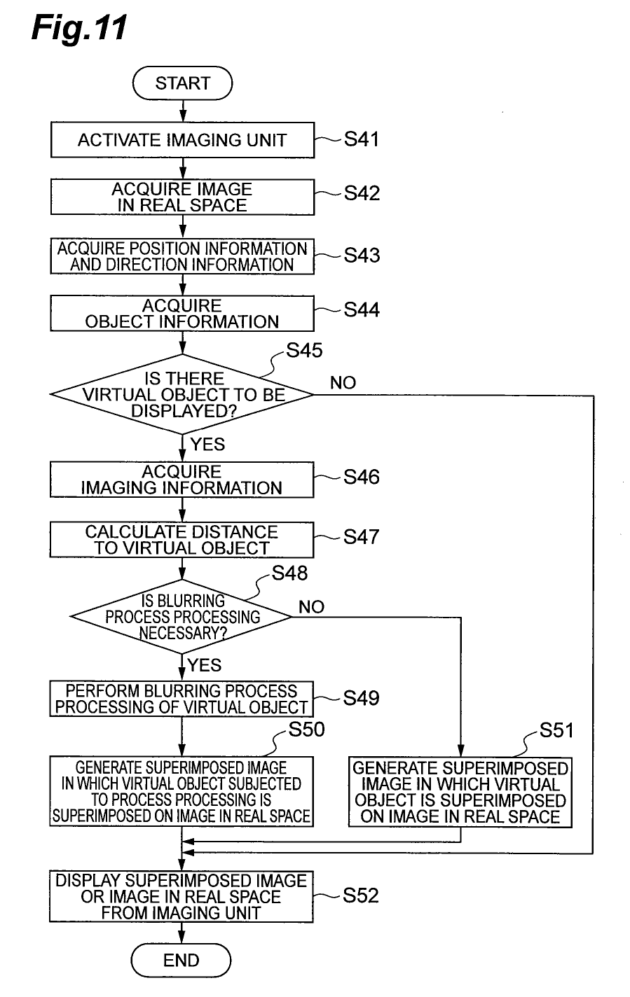

Next, referring to a flowchart in FIG. 11, the processing content of the object display method in the case where the object display device 1 carries out the blurring process will be described.

First, the processing content of steps S41 to S45 in the flowchart in FIG. 11 is similar to the processing content of steps S21 to S25 in the flowchart in FIG. 10.

Subsequently, the camera information acquisition unit 14 acquires the imaging information including the focal length that the imaging unit 13 has used (S46). This imaging information may include information of the depth of field. Next, the virtual object distance calculation unit 20 calculates the distance from the object display device 1 to the virtual object based on the position information measured by the position measurement unit 18 and the position information of the virtual object included in the virtual object information (S47).

Next, the virtual object process unit 15 determines the necessity of the blurring process for each object (S48). That is, in the case where the arrangement position of the virtual object is included in a region to which the focal length is caused to correspond in the image in real space, the virtual object process unit 15 determines that the blurring process with respect to the object is not necessary. In the case where the arrangement position of the virtual object is not included in the region to which the focal length is caused to correspond in the image in real space, the virtual object process unit 15 determines that the blurring process with respect to the object is necessary. In the case where it is determined that the blurring process is necessary, the processing procedure proceeds to step S49. In the case where the object for which the blurring process is determined to be necessary is absent, the processing procedure proceeds to step S51.

In step S49, the virtual object process unit 15 carries out the blurring process with respect to the virtual object (S49). Subsequently, the image synthesis unit 16 generates the superimposed image in which the object for which process processing has been performed in step S7 is superimposed on the image in real space acquired by the imaging unit 13 (S50). In step S51, the image synthesis unit 16 generates the superimposed image in which the object for which the process processing is not performed is superimposed on the image in real space acquired by the imaging unit 13 (S51). Then, the display unit 17 displays the superimposed image generated by the image synthesis unit 16 in step S50 or S51 or the image in real space on which the object is not superimposed (S52).

With the object display device and the object display method of the second embodiment described above, what is called the blurring process is carried out using the focal length that the imaging unit 13 has used, in the case where the object is located in a position that is out of focus in the image in real space, with respect to the object, in addition to the process processing such as the noise process and the color correction process in the first embodiment. Accordingly, since the object for which the blurring process has been carried out is superimposed in a region that is out of focus in real space, a superimposed image in which a sense of incongruity is reduced is obtained.

Note that although a case where the noise process and the color correction process are carried out based on the set value included in the imaging information has been described with reference to FIG. 10 and a case where the blurring process is carried out based on the parameter such as the focal length has been described with reference to FIG. 11, it may be such that a combination of the process processing is carried out with respect to one object.

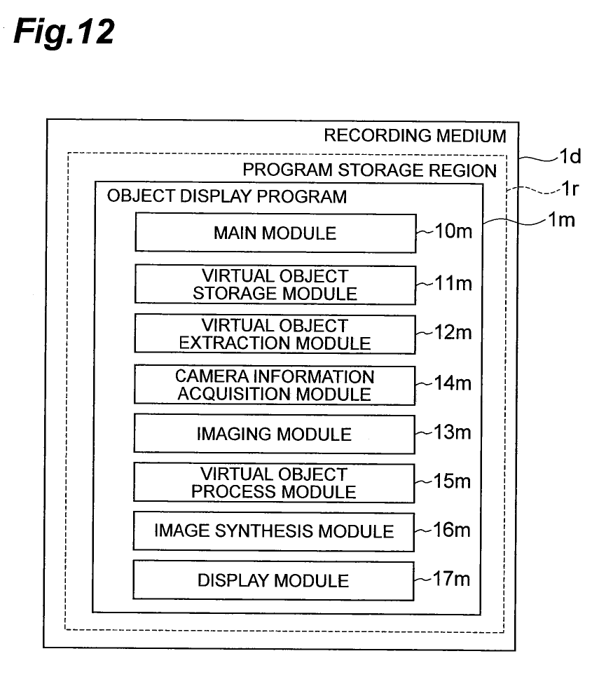

Next, an object display program for causing a computer to function as the object display device 1 of this embodiment will be described. FIG. 12 is a view showing the configuration of an object display program 1m corresponding to the object display device 1 shown in FIG. 1.

The object display program 1m is configured to include a main module 10m that entirely controls object display processing, a virtual object storage module 11m, a virtual object extraction module 12m, an imaging module 13m, a camera information acquisition module 14m, a virtual object process module 15m, an image synthesis module 16m, and a display module 17m. Then, respective functions for the respective functional units 11 to 17 in the object display device 1 are achieved by the respective modules 10m to 17m. Note that the object display program 1m may be in a form transmitted via a transmission medium such as a communication line or may be in a form stored in a program storage region 1r of a recording medium 1d as shown in FIG. 12.

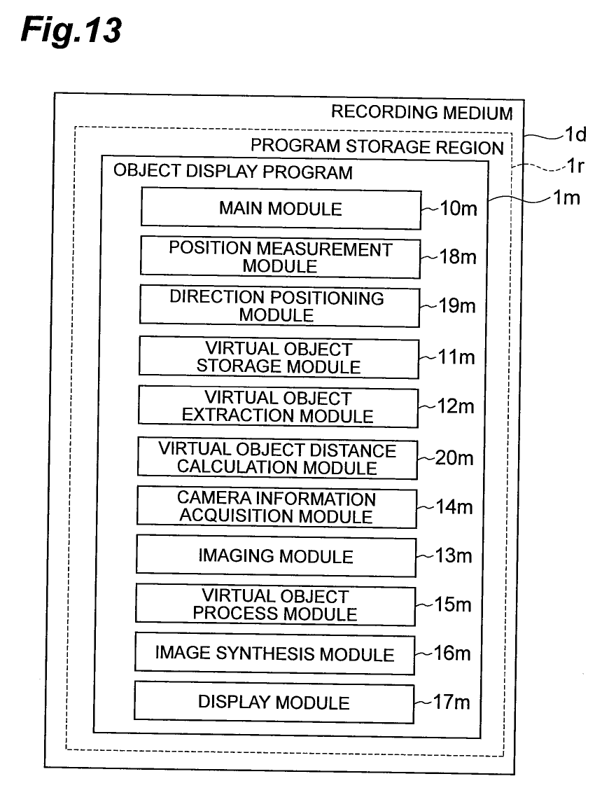

FIG. 13 is a view showing the configuration of the object display program 1m corresponding to the object display device 1 shown in FIG. 7. The object display program 1m shown in FIG. 13 includes, in addition to the respective modules 10m to 17m shown in FIG. 12, a position measurement module 18m, a direction positioning module 19m, and a virtual object distance calculation module 20m. Functions for the respective functional units 18 to 20 in the object display device 1 are achieved by the respective modules 18m to 20m.

The present invention has been described above in detail based on the embodiments thereof. However, the present invention is not limited to the embodiments described above. For the present invention, various modifications are possible without departing from the gist thereof.

### INDUSTRIAL APPLICABILITY

The present invention can reduce a sense of incongruity upon superimposing and displaying an object on an image in real space easily in AR technology.

### REFERENCE SIGNS LIST

1 . . . object display device, 11 . . . virtual object storage unit, 12 . . . virtual object extraction unit, 13 . . . imaging unit, 14 . . . camera information acquisition unit, 15 . . . virtual object process unit, 16 . . . image synthesis unit, 17 . . . display unit, 18 . . . position measurement unit, 19 . . . direction positioning unit, 20 . . . virtual object distance calculation unit, 1m . . . object display program, 1d . . . recording medium, 10m . . . main module, 11m . . . virtual object storage module, 12m . . . virtual object extraction module, 13m . . . imaging module, 14m . . . camera information acquisition module, 15m . . . virtual object process module, 16m . . . image synthesis module, 17m . . . display module, 18m . . . position measurement module, 19m . . . direction positioning module, 20m . . . virtual object distance calculation module, V₁, V₂, V₃, V₄, V₅, V₆, V₇ . . . object

1. An object display device that superimposes and displays an object on an image in real space, the object display device comprising:
an object information acquiring unit configured to acquire object information relating to the object to be displayed;
an imaging unit configured to acquire the image in real space;
an imaging information acquiring unit configured to acquire imaging information that the imaging unit references upon acquisition of the image in real space;
an object process unit configured to process, based on the imaging information acquired by the imaging information acquiring unit, the object acquired by the object information acquiring unit;
an image synthesizing unit configured to generate an image in which the object processed by the object process unit is superimposed on the image in real space acquired by the imaging unit; and
a display unit configured to display the image generated by the image synthesizing unit.

2. The object display device according to claim 1, further comprising:
a position measuring unit configured to measure a location of the object display device; and
an object distance calculating unit, wherein
the object information includes position information representing an arrangement position of the object in real space,
the imaging information includes a focal length,
the object distance calculating unit calculates a distance from the object display device to the object based on the position information of the object acquired by the object information acquiring unit and the location of the object display device measured by the position measuring unit, and
the object process unit performs, with respect to the object, a blurring process for imitating an image acquired in a case where an imaging subject is present at a position displaced from the focal length, in accordance with a difference of the focal length included in the imaging information acquired by the imaging information acquiring unit and the distance to the object calculated by the object distance calculating unit.

3. The object display device according to claim 1, wherein
the imaging information includes a set value relating to image quality upon acquiring the image in real space, and
the object process unit processes the object in accordance with the set value included in the imaging information acquired by the imaging information acquiring unit.

4. The object display device according to claim 3, wherein
the imaging information includes responsivity information with which responsivity in the imaging unit is determined, and
the object process unit carries out a noise process of adding a particular noise to the object in accordance with the responsivity information included in the imaging information acquired by the imaging information acquiring unit.

5. The object display device according to claim 3, wherein
the imaging information includes color correction information with which a color of the image acquired by the imaging unit is corrected, and
the object process unit carries out a color correction process of correcting a color of the object in accordance with the color correction information included in the imaging information acquired by the imaging information acquiring unit.

6. An object display method performed by an object display device that superimposes and displays an object on an image in real space, the object display method comprising:
an object information acquisition step of acquiring object information relating to the object to be displayed;
an imaging step of acquiring the image in real space;
an imaging information acquisition step of acquiring imaging information that is referenced upon acquisition of the image in real space in the imaging step;
an object process step of processing, based on the imaging information acquired in the imaging information acquisition step, the object acquired in the object information acquisition step;
an image synthesis step of generating an image in which the object processed in the object process step is superimposed on the image in real space acquired in the imaging step; and
a display step of displaying the image generated in the image synthesis step.

7. A non-transitory computer readable medium including computer executable instructions for causing a computer to function as an object display device that superimposes and displays an object on an image in real space, causing the computer to implement:
an object information acquisition function of acquiring object information relating to the object to be displayed;
an imaging function of acquiring the image in real space;
an imaging information acquisition function of acquiring imaging information that the imaging function references upon acquisition of the image in real space;
an object process function of processing, based on the imaging information acquired with the imaging information acquisition function, the object acquired with the object information acquisition function;
an image synthesis function of generating an image in which the object processed with the object process function is superimposed on the image in real space acquired with the imaging function; and
a display function of displaying the image generated with the image synthesis function.
